(19) United States
(12) Patent Application Publication
(10) Pub. No.: US 2021/0305602 A1
(43) Pub. Date: Sep. 30, 2021

(54) METHOD FOR INSPECTING GAS LEAK FROM FUEL CELL STACK

(71) Applicant: HONDA MOTOR CO., LTD., Tokyo (JP)

(72) Inventors: Yusuke OKABE, Tochigi (JP); Satoshi HASEGAWA, Tochigi (JP); Hiroshi SEKIGUCHI, Tochigi (JP); Toru IKEDA, Tochigi (JP)

(21) Appl. No.: 17/207,753

(22) Filed: Mar. 22, 2021

(30) Foreign Application Priority Data
Mar. 26, 2020 (JP) 2020-055669

(51) Int. Cl. H01M 8/04664; G01M 3/04

(52) U.S. Cl. CPC H01M 8/04679; G01M 3/04

(57) ABSTRACT

To provide a method for inspecting a gas leak from a fuel cell stack, whereby a leak position can be easily identified in a short time. A method for inspecting a gas leak from a fuel cell stack includes a preparation step of arranging stacked end faces of the fuel cell stack so as to be exposed on a side surface, a jig installation step of installing an inspection jig including a space for detecting the gas leak from the side surface so as to cover the side surface, a gas leak measurement step of detecting the gas leak with a gas sensor arranged in an upper part in the space, and a position identification step of identifying a leak position in a height direction from a detection start time of the gas sensor.

This application is based on and claims the benefit of priority from Japanese Patent Application No. 2020-055669, filed on 26 Mar. 2020, the content of which is incorporated herein by reference.

### BACKGROUND OF THE INVENTION

### Field of the Invention

The present invention relates to a method for inspecting a gas leak from a fuel cell stack.

### Related Art

A fuel cell has a stack structure in which, for example, tens to hundreds of cells are stacked.

Each cell is configured by sandwiching a membrane electrode assembly (MSA) between a pair of separators, and the MEA is composed of two electrodes of an anode electrode (anode) and a cathode electrode (cathode), and a solid polymer electrolyte membrane sandwiched between these electrodes.
When hydrogen gas as a reaction gas is supplied to the anode electrode of the fuel cell, and air containing oxygen as a reaction gas is supplied to the cathode electrode, electric power is generated by an electrochemical reaction.

Since the fuel cell uses hydrogen, it is necessary to completely prevent hydrogen leaks from the fuel cell stack. Therefore, a method for effectively detecting hydrogen leaks in the state of a fuel cell stack has been studied.

For example, Patent Document 1 below identifies a leak position by detecting a temperature change during a leak with an infrared sensor.

Patent Document 1: Japanese Unexamined Patent Application, Publication No. 2006-156038

### SUMMARY OF THE INVENTION

The temperature change due to a hydrogen leak in a fuel cell stack is very small.

Therefore, in the method of Patent Document 1, it is difficult to identify hydrogen leaks with high accuracy.

Another possible method is to submerge a fuel cell stack in water and identify a leak position based on the position of bubbles. However, this method may falsely detect a leak due to the detection of air bubbles attached to the fuel cell stack when it is submerged in water. Further, since it requires a process to dry the submerged fuel cell stack, it takes time to identify the leak position. Thus, a method that can identify the leak position in a short time has been required.

In response to the above issues, it is an object of the present invention to provide a method for inspecting a gas leak from a fuel cell stack, whereby a leak position can be easily identified in a short time.

The present inventors have found that a detection start time of a gas sensor correlates with a leak position in the height direction of a fuel cell stack, and completed the present invention.

Specifically, the present invention provides the following.

A first aspect of the present invention is an inspection method for identifying a position of a gas leak from a fuel cell stack in which a plurality of fuel cell cells are stacked.

The method includes a preparation step of arranging stacked end faces of the fuel cell stack so as to be exposed on a side surface;
a jig installation step of installing an inspection jig including a space for detecting the gas leak from the side surface so as to cover the side surface;
a gas leak measurement step of detecting the gas leak with a gas sensor arranged in an upper part in the space; and
a position identification step of determining in advance a relationship between a detection start time of the gas sensor and a leak height position in a height direction of the fuel cell stack in the gas leak measurement step, and identifying the leak height position from the detection start time of the gas sensor.

A second aspect of the present invention is an inspection method for identifying a position of a gas leak from a fuel cell stack in which a plurality of fuel cell cells are stacked.

The method includes a preparation step of arranging stacked end faces of the fuel cell stack so as to be exposed on a side surface;
a jig installation step of installing an inspection jig including a space for detecting the gas leak from the side surface so as to cover the side surface;
a gas leak measurement step of detecting the gas leak with a gas sensor arranged in an upper part in the space; and
a position identification step of determining in advance a relationship among a detection start time of the gas sensor, an amount of leaked gas, and a leak height position in a height direction of the fuel cell stack in the gas leak measurement step, and identifying the leak height position from the detection start time of the gas sensor and the amount of leaked gas.

In a third aspect of the present invention according to the first or second aspect, in the preparation step, the fuel cell cells are stacked in a vertical direction.

According to the method for inspecting a gas leak from a fuel cell stack of the present invention, it is possible to easily identify a leak position in a short time.

### BRIEF DESCRIPTION OF THE DRAWINGS

FIG. 1 is a schematic cross-sectional view illustrating an embodiment of an inspection method of the present invention;

FIG. 2 is a graph conceptually illustrating the leak state in a position identification step;

FIG. 3A is a graph illustrating gas leak results in an Example; and

FIG. 3B is a graph illustrating gas leak results in the Example.

### DETAILED DESCRIPTION OF THE INVENTION

### First Embodiment

An embodiment of the present invention will be described with reference, to the drawings.

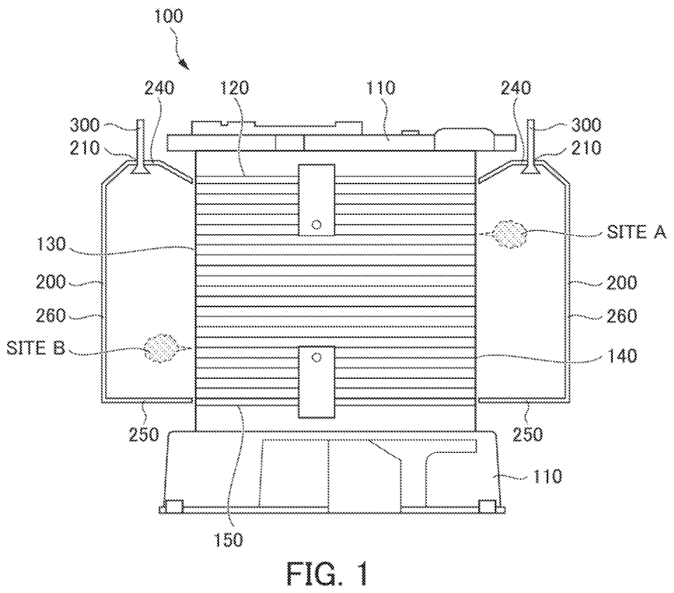

FIG. 1 is a schematic cross-sectional view illustrating an embodiment of an inspection method of the present invention.

### (Fuel Cell Stack)

As shown in FIG. 1, a fuel cell stack 100 in this embodiment has a stack structure in which tens to hundreds of rectangular and planar unit cells are stacked.

Each unit cell is configured by sandwiching a membrane electrode assembly (MEA) between a pair of separators. The MEA includes two electrodes of an anode electrode (anode) and a cathode electrode (cathode), and a solid polymer electrolyte membrane sandwiched between these electrodes.
When hydrogen gas as a reaction gas is supplied to the anode electrode of the fuel cell, and air containing oxygen as a reaction gas is supplied to the cathode electrode, electric power is generated by an electrochemical reaction.

As shown in FIG. 1, the fuel cell stack 100 in this embodiment is configured such that the unit cells are stacked in a vertical direction.

The stacked cells are fixed by a pair of end plates 110, sandwiched between the unit cell of the top layer on the side of a top surface 120 and the unit cell of the bottom layer on the side of a bottom surface 150.

Thus, the outer surfaces of the fuel cell stack 100 consist of six surfaces: the top and bottom end plates 110, and four outer surfaces in which the stacked end faces of the unit cells are exposed, i.e., a left side surface 130, a right side surface 140, a front surface 160 (not shown), and a back surface 170 (not shown).

### (Inspection Jig)

As shown in FIG. 1, an inspection jig 200 for performing gas leak inspection covers at least one outer surface so as to surround it in a circumferential manner. In this embodiment, the inspection jig 200 covers all outer surfaces, i.e., a left side surface 130, a right side surface 140, a front surface 160 (not shown), and a back surface 170 (not shown).

The inspection jig 200 includes a bottom 250 that horizontally extends from an outer surface near the bottom surface 150; a body 260 that extends, parallel to the outer surface (upward in FIG. 1), from the extension end of the bottom 250 to the height of the top surface 120 of the outer surface; and a horizontal top (not shown) that horizontally extends from the extension end of the body 260 to the end on the left side surface 130 side of the top surface 120. In the cross-section of FIG. 1, a conical inspection portion 240 is provided instead of the horizontal top.

The inspection portion 240 includes a hole 210 at the top.
The inspection jig 200 is in close contact with an outer surface of the fuel cell stack 100 at the edge of the bottom 250 and at the edge of the horizontal top or the inspection portion 240.
In this embodiment, one inspection portion 240 is provided for each outer surface.

In the present invention, at least one of the four outer surfaces may be covered, or only a part of an outer surface may be covered, but it is necessary to cover the entire range in the height direction of the fuel cell stack 100.

In the present invention, it is preferable to cover all outer surfaces for easier inspection.
In this case, an inspection jig may cover all outer surfaces, or a plurality of inspection jigs may respectively cover the outer surfaces.

The inspection jig 200 may be formed of metal, resin, or the like.

### (Sensor)

The cross-section of the inspection portion 240 is hollow and has a substantially truncated quadrangular pyramid shape, and a hole 210 for inserting and fixing a gas sensor 300 is formed on the top surface thereof.

The inspection portion 240 is preferably formed in a pyramidal or a hemispherical shape, narrowing in width as it extends from its base. Thus, gas tends to gather at the top of an upper part, making it easier for the gas sensor 300 to detect leaked gas.
The gas sensor 300 is arranged inside a divided space through the hole 210.
For example, to detect helium gas, a conventionally known He detector or the like can be used.

The sensor 300 is preferably provided above the top surface 120 of the fuel cell stack 100.

This allows gas leaks from cells of all height positions to be detected.
Note that the number of the inspection portions 240 and the sensors 300 in the inspection jig 200 is not particularly limited.
As in this embodiment, the inspection portion and the sensor may be arranged for each outer surface of the fuel cell stack 100, or one inspection portion and one sensor may be arranged in the entire fuel cell stack 100.
(Method for inspecting Gas Leak from Fuel Cell Stack)

The gas leak inspection method of the present invention will be described with reference to FIGS. 1 to 3B.

### (Preparation Step)

First, the fuel cell stack 100 to be inspected is prepared, in this Example, the above-described fuel cell stack 100 was used as the fuel cell stack to be inspected, and unit cells were stacked in a vertical direction.

In the present invention, since leak positions in a height direction are detected, it is preferable that the unit cells are stacked in the vertical direction.
This makes it easier to identify a cell in which a leak is detected. When the unit cells are stacked in a horizontal direction, in the preparation step, they may be rotated so as to be stacked in a vertical direction.
That is, the present invention can be applied not only when the unit cells are stacked in a vertical direction, but also when the unit cells are stacked in a horizontal direction.

### (Jig Installation Step)

Next, as shown in FIG. 1, the inspection jig 200 is arranged so as to cover and be in close contact with the outer surfaces of the fuel cell stack 100, i.e., the left side surface 130, the right side surface 140, the front surface 160 (not shown), and the back surface 170 (not shown), and a He detector as the gas sensor 300 is arranged in an upper part in the divided inspection portion 240.

### (Gas Leak Measurement Step)

In this state, the presence or absence of a leak of helium gas from the unit cells of the fuel cell stack 100 was measured by the gas sensor 300.

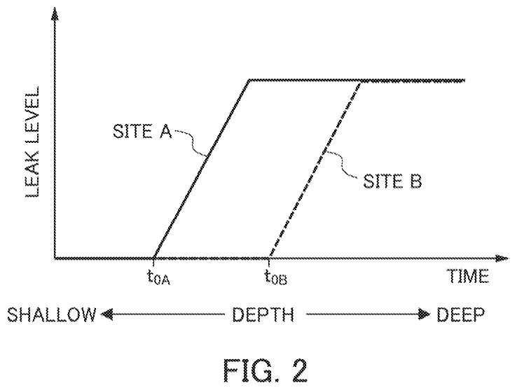

In this embodiment, an example is used in which leaks are present at two positions, i.e., site A present in an upper part of the fuel cell stack 100 and site B present in a lower part of the fuel cell stack 100.
As shown in FIG. 2, two gas leaks at sites A and B were detected.

### First Embodiment of Position Identification Step

FIG. 2 is a graph conceptually illustrating the results of the gas leak inspection.

FIG. 2 illustrates general examples in which detection curves rise at predetermined angles from rise start times t_{0A} and t_{0B}, and then become substantially a constant value at predetermined times.

In this embodiment, site A is closer to the gas sensor 300 than site B. This difference in distance, i.e., the difference in leak height position is reflected in the rise time of leak detection (detection start time in the present invention).

As a result, as shown in FIG. 2, a time difference appears in which the curve representative of site A begins at an earlier time than the curve representative of site B, which begins at a later time.
Utilizing this, the relationship between the detection start time of the gas sensor and the leak height position in the height direction of the fuel cell stack is determined in advance, and thereby it is possible to identify the leak height position from the detection start time of the gas sensor.

For the relationship between the detection start time of the gas sensor and the leak height position in the height direction of the fuel cell stack, for example, the detection start time may be determined in advance by arranging a dummy cell with a predetermined leak at a predetermined height. Alternatively, the detection start time may be determined by simulation.

### Second Embodiment of Position Identification Step

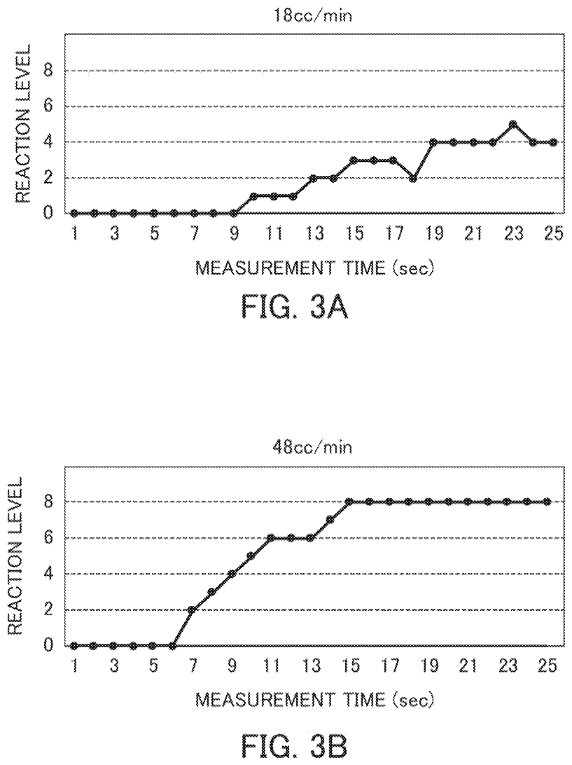

Note that the rise time of leak detection in FIG. 2 also depends on an amount of leaked gas as shown in FIGS. 3A and 3B.

Specifically, in FIG. 3A, the amount of helium gas leaking from the leak is 18 cc/min, and the rise time in this case is 9 seconds. whereas, in FIG. 3B, the amount of helium gas leaking from the leak is 48 cc/min, and the rise time in this case is 6 seconds and shorter. This means that, even if leaks occur at the same position, the rise time also depends on the amount of gas leaking from the leak.
In addition, both cases also have different reaction levels (detected values) on the vertical axis in FIGS. 3A and 3B.

In this manner, if there is a significant difference in the amount of leaked gas between the two, it will affect the rise time and not result in the same rise time.

In this case, the relationship among the detection start time of the gas sensor, the amount of leaked gas, and the leak height position in the height direction of the fuel cell stack is determined in advance, and thereby it is possible to identify the leak height position from the detection start time of the gas sensor and the amount of leaked gas, not only from the rise time (detection start time in the present invention).

For the relationship among the detection start time of the gas sensor, the amount of leaked gas, and the leak height position in the height direction of the fuel cell stack, for example, the leak height position may be determined by arranging different, dummy cells with different amounts of leaked gas at a predetermined height, determining the respective detection start times in advance, and correcting the detection start time when the amount of leaked gas is the same.

Alternatively, in FIG. 2 and FIG. 3, the leak height position may be identified by performing a predetermined correction calculation, considering at least one selected from, at different amounts of leaked gas, the rise angles of the reaction levels (detected values), the reaction levels (detected values) at saturation, the areas (integral values) surrounded by the reaction levels (detected values) within a predetermined time period, and the like, in addition to the detection start time.

### EXPLANATION OF REFERENCE NUMERALS

100 fuel cell stack
110 end plate
120 top surface
130 left side surface
140 right side surface
150 bottom surface
200 inspection jig
210 hole
240 inspection portion
250 bottom
260 body
300 gas sensor

What is claimed is:

1. An inspection method for identifying a position of a gas leak from a fuel cell stack In which a plurality of fuel cell cells are stacked, the method comprising:
a preparation step of arranging stacked end faces of the fuel cell stack so as to be exposed on a side surface;
a jig installation step of installing an inspection jig including a space for detecting the gas leak from the side surface so as to cover the side surface;
a gas leak measurement step of detecting the gas leak with a gas sensor arranged in an upper part in the space; and
a position identification step of determining in advance a relationship between a detection start time of the gas sensor and a leak height position in a height direction of the fuel cell stack in the gas leak measurement step, and identifying the leak height position from the detection start time of the gas sensor.

2. An inspection method for identifying a position of a gas leak from a fuel cell stack in which a plurality of fuel cell cells are stacked, the method comprising:
a preparation step of arranging stacked end faces of the fuel cell stack so as to be exposed on a side surface;
a jig installation step of installing an inspection jig including a space for detecting the gas leak from the side surface so as to cover the side surface;
a gas leak measurement step of detecting the gas leak with a gas sensor arranged in an upper part in the space; and
a position identification step of determining in advance a relationship among a detection start time of the gas sensor, an amount of leaked gas, and a leak height position in a height direction of the fuel cell stack in the gas leak measurement step, and identifying the leak height position from the detection start time of the gas sensor and the amount of leaked gas.

3. The method according to claim 1, wherein, in the preparation step, the fuel cell cells are stacked in a vertical direction.
